(19) United States
(12) Patent Application Publication
(10) Pub. No.: US 2010/0010844 A1
(43) Pub. Date: Jan. 14, 2010

(54) Method of Identifying and Prioritizing New Product Concepts and Development

(76) Inventor: Scott G. Isaksen, Orchard Park, NY (US)

Correspondence Address: Jaekle Fleischmann & Mugel, LLP, 12 Fountain Plaza, Buffalo, NY, 14202-2292, US

(21) Appl. No.: 12/169,279

(22) Filed: Jul. 8, 2008

(51) Int. Cl. G06F 17/50

(52) U.S. Cl. 705/7

(57) ABSTRACT

A product development process directed to elicit previously unknown, unmet needs of consumer group participants using, in a principal aspect of the invention, guided imagery in the idea discovery stage.

### BACKGROUND OF THE INVENTION

The present invention relates to novel product development processes. More particularly, the present invention relates to a product development process directed to elicit previously unknown, unmet needs of consumer group participants using, in a principal aspect of the invention, guided imagery in the idea discovery stage.

For many businesses to grow and be successful, they must constantly develop and bring new products to market for their customers. This is especially true for consumer products (e.g., in the electronics field). “New product development” is the common term for the process by which businesses develop new products. The first stage to the product development process is identifying what types of new products and/or new product features to develop and bring to market. This is commonly referred to as the “discovery stage” or the “fuzzy front-end,” and typically involves the use of market surveys and focus groups to assist in developing and prioritizing a list of new product ideas. A market survey may be provided in the form of a written questionnaire or a verbal polling of a group of people based on their consumer profiles having relevance to the applicable business sector (e.g., college graduates in the 25-35 year old range may be an appropriate group to survey in the handheld personal digital assistant business sector). The market survey provides a list of previously prepared questions directed to ascertain the features people may be interested in seeing in a new product. The market survey looks for answers from preset questions and may thus be regarded as a “push” type survey in that it usually gives the only choices available to the participant rather than allowing the participant to create their own questions and answers. The market survey is thus biased toward the survey author rather than drawing out raw, unbiased information from the participant.

The focus group recruits a group of consumers and is directed by a moderator. A marketing team may be allowed to view the focus group sessions behind one-way glass. Notes are taken based on how the focus group chooses from, or reacts to, a set of predetermined items and possibly accompanying questions about the item. This is designed to help show people's likes/dislikes of products presently under development consideration. As with the market survey, the focus group method is very limiting in the information it obtains in that the participants are asked to respond to items preselected from the focus group designer. The focus group is thus also biased toward the focus group designer rather than drawing out raw, unbiased information from the participant.

The market survey and focus group techniques have been used for many years but each have many drawbacks as discussed above. One underlying problem is that people many times do not even know themselves what they might need or prefer for a new product. And, even if they do know, they might not be able to put these “needs” into words.

A market survey or focus group is thus not designed to elicit new concepts—it merely provides an already predefined set of ideas from which the participants choose based on what they think, at that particular time, they might need or like. The use of preselected ideas to which a person must respond does not allow a person to come up with their own ideas as to what new products or product features they might need or like. Furthermore, the process of idea generation, including identifying needs and wants, is not a straight-forward process. The human mind has a subconscious which can influence the conscious mind. There are many ideas, needs and wants which may exist only in the subconscious mind of which the person is generally unaware. The present invention successfully brings or “pulls” those previously unappreciated unconscious needs and wants of the participant to the conscious mind such that they can be identified and understood by the market researcher. As explained more fully below, the inventive method accomplishes this by beginning the process with techniques that go below language. The present invention is thus a true “pull” type marketing research tool in that it obtains new consumer ideas in their most raw, unbiased form from across a diverse consumer group.

### SUMMARY OF THE INVENTION

The present invention addresses the above noted drawbacks with present day market research and product development techniques by providing, in a first aspect, a method which “pulls” previously unidentified needs and wants from participants by first engaging them in a guided imagery exercise. Using imagery to elicit previously unrecognized needs and wants from consumers “gets below language” and is believed to be extremely effective at bringing forth the most promising ideas for possible product development. Only once the needs and wants are elicited using imagery is language used to begin putting the needs and wants into a defined set of problems. Once problems are defined, a list of ideas may then be generated for further analysis and ranking.

As a first step, the participants are selected to form a group of the desired diversity appropriate for the particular client engagement (the “client” refers to the company on whose behalf the research is being conducted). More particularly, possible participants are screened to identify characteristics unique to each participant. The characteristic(s) may be the participant's problem-solving style, for example, which is determined through administration of a set of questions designed to determine the desired personal characteristic as determined appropriate by the client team. It is noted the participant screening may be conducted in steps if desired, for example, a basic screening to obtain a large pool of possible participants followed by a more detailed screening to obtain the final group of participants.

Once the desired group is formed, the participants are first briefed by a facilitator to provide the participants with basic information concerning the project. The participants are then coaxed into a physiological state most conducive to a guided imagery process. This may be accomplished using progressive relaxation techniques, for example. Once the participants have been led into this relaxed state, they are brought through a guided imagery routine wherein the facilitator reads a “guided-imagery script” custom designed to encourage imagery formation linked to the relevant business sector by the participants. This step may be performed with the simultaneous delivery of brain entrainment such as through the playing of appropriate background music. This ensures the desired physiological and psychological state is maintained throughout the guided imagery process.

The goal of guided imagery is to help participants identify archetypal images which are images usually associated with early or “imprinted” experiences. Archetypal images are thus considered to have deep meaning and interpretive value. As an example, the guided imagery script may ask the participants to think about a time in their life when they felt the most entertained. As the participants think about this time, they are encouraged to form mental images (below language) and take a “mental snapshot” of the image(s) for later recollection. Immediately following the guided imagery, participants are asked to write down a title for each of their guided imagery visits, along with one or more short descriptions of the mental pictures they formed during the process. They then join their individual groups and share their personal imagery experiences with the group under the guidance of the facilitator. For example, the facilitator may help the group identify similar themes among their various imagery experiences. These themes provide the “springboards” of the problem finding phase during which participants generate many varied and unusual problem statements as discussed further below.

Thus, as described above, the individual groups are previously determined according to the desired segmentation and targeting. Facilitators encourage participants to convert their mental pictures into a comprehensive description of ideas. Images, sounds, smells, feelings, and associated memories are all recorded in the form of field notes from facilitators, notes of flipcharts for all to see, and/or digital audio recording for further discussion with the group and use afterwards. Thus, it is only at this stage where descriptive language begins to be associated with the images and made more conscious.

### BRIEF DESCRIPTION OF THE DRAWINGS

FIG. 1 is a flow chart showing the four basic phases of a project in accordance with the invention; and

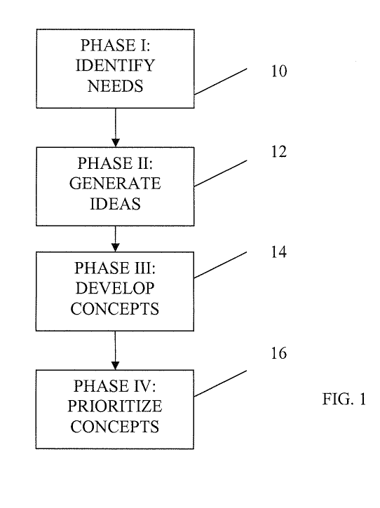

FIG. 2 is a flow chart showing basic steps of the four main phases of FIG. 1.

### DETAILED DESCRIPTION

Referring to the figures, Phase 1 of the process identified at block 10 first involves the identification of needs. For example, a company wants to know what is the next great product they should develop and commercialize which would be a blockbuster hit with their customers. In order to know what kind of product to develop, they first need to know the customer's need that the product will satisfy. This is what they do not know and what Phase 1 of the process aims to identify. Thus, Phase 1 identifies a need or needs. This is accomplished using the inventive method which draws out or “coaxes” a deep-seated need which may be buried within a person's subconscious—a need which the person previously unrecognized and unappreciated as a real need—a need so important that, if a product was offered to satisfy that need, the person would buy it without little or no hesitation. It is therefore of the utmost importance that the need identification process be designed and structured such that it is not just any need that is borne out. If the need that is identified is not a deep-seated need, the consumer's reaction to a new product developed to satisfy a less important need may turn out to be just a “nice to have”. This type of need is not what a company is really after in new product development and not what the present inventive process is directed at. Companies are looking for blockbuster products—products that consumers simply must have and cannot do without. Phase 1 of the inventive process is thus designed and structured to identify a customer's deep-seated need which is truly capable of producing a new blockbuster product.

Knowing the importance of the need generation stage, the first step is to select the project team members that will select and direct participants through the study. This usually involves one or two people from the company on who's behalf the study is being conducted who have a keen interest in the study. These may be people selected from the marketing group who are responsible for developing the company's marketing strategy, for example. These people are actual team members (sometimes referred to as “Company” or “Project” team members herein) who will interact with the participants. It is believed this aids in the successful outcome of the project by allowing the company team members to have direct and personal interaction with the participants—not through a one-way mirror where company observers sit as is done in typical focus group studies, or through reading of completed surveys that have been previously filtered by the survey company. In addition to company team members, one or two facilitators certified in carrying out the inventive method (sometimes also referred to as “CPSB” team members herein) are included to help guide the company team members, participants and process through its various stages. Qualified CPSB team members use the common tools, guidelines and language of the inventive method and are trained to ensure the process is carried out in the proper manner. The selection of the right team members is thus a carefully thought-out part of the process.

There are thus three basic groups of players involved in the inventive process: the facilitators or CPSB team members; the Company or Project team members; and the recruited participants.

Once the Project and CPSB teams have been identified, they work together to determine what participants and groups they will need. This may be determined by first identifying the relevant market segment of the company. For example, what is the relevant market segment they are targeting for this new product development study? Is it hand held electronics? Is it all-purpose household cleaners? Is it a product to assist the elderly in their home? Once the market segment is identified, the next question is what are the demographics of the consumers in that target market segment? Is it people that were early adopters of wireless technology? Is it young parents or head of household or elderly homeowners? This will help define the demographic mix of the participant pool from which the ultimate participants will be chosen (e.g., young professionals 26 to 35 years old having at least a bachelor's degree would be appropriate for handheld electronics market segment).

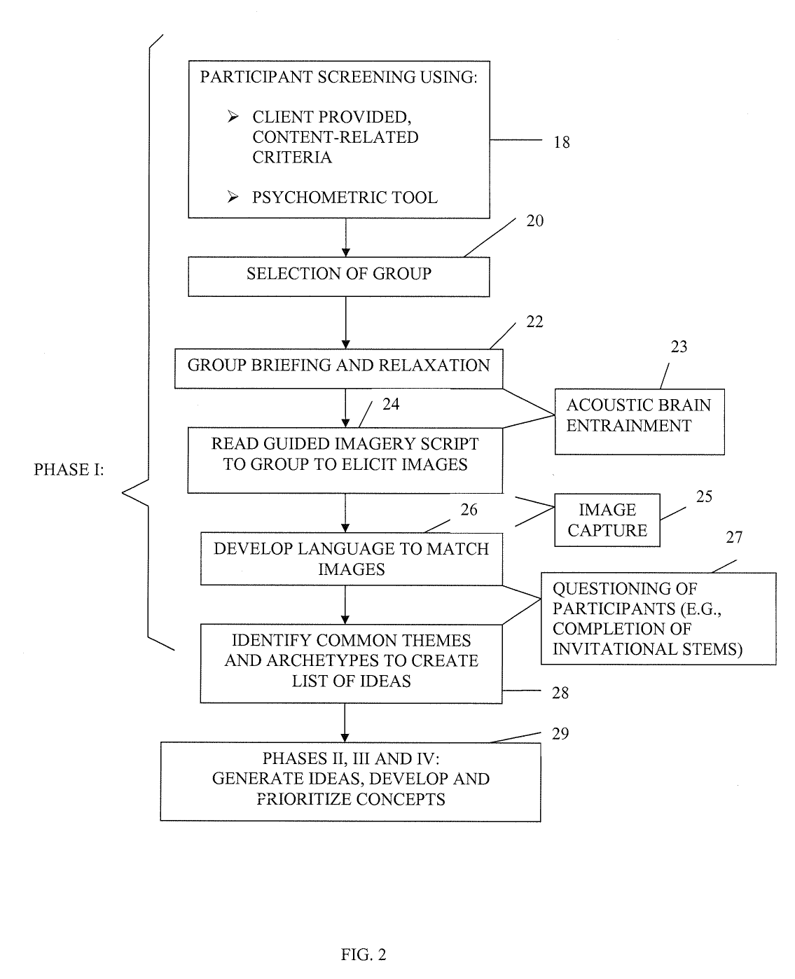

In typical market research focus groups, the participants are selected primarily according to demographics (e.g., age and sex). The present invention goes a step further by screening the participants according to one or more personal characteristics which are determined by using a psychometric tool involving administering a set of questions to each participant. An example of a suitable psychometric tool is called “VIEW: An Assessment of Problem Solving Style” available through Center for Creative Learning in Sarasota, Fla. or by visiting www.creativelearning.com. The predetermined characteristic may be a person's problem-solving style which may include one or more of orientation to change, manner of processing information, and ways of deciding options, for example. Orientation to change may include explorer or developer styles. The manner of processing information may include external or internal style. The ways of deciding options may include a person style or task style. A set of questions designed to identify the desired characteristics are then administered to the pool of participants. Certain requirements would put potential participants in a larger pool, e.g, they must be end-users of a particular type of product. In addition, the psychometric profile of the groups may require a mix of explorers and developers. The final selection will ensure the appropriate mix within each of the groups. Those having the desired characteristic(s) are selected as participants of the study (see block 20 in FIG. 2).

The final participants may be divided into different groups. For example, in hand-held wireless devices, there may be the enterprise group (companies are the consumer); government group (government is the consumer), and individual consumer group (individual consumers). The participant selection process may therefore include questions designed to decide which group a participant should be assigned. For example, people having a background in a company's purchasing group could be assigned to the enterprise group. It is noted that a group consists of at least one, but preferably several, participants.

Once all the participants and groups have been identified, all the participants are assembled in a room where they can feel safe and relaxed. The participants are briefed on the general agenda and the value and use of imagery. The participants are then guided into a relaxed physical and mental state using relaxation techniques such as deep, silent breathing, for example. (see block 22 in FIG. 2). Yoga mats may be provided to allow the participants to lie down while being briefed and relaxed. The team member tells them why they are there and how they will work together (e.g., “you are here to participate in a study to help company XYZ, which sells products in the ABC market, decide what kind of new product they want to develop and bring to market”). This briefing makes the entire process more transparent to the participants and is believed to aid in the success of the further stages of the process. This is also quite the opposite of typical focus groups where the participants usually don't know why they're there or who the company is that is sponsoring the focus group.

It is preferred the project team member speak first and last. After telling the participants why they are there, the Project or CPSB team member tells them the importance of imagery—for example how humans rely on images in every aspect of life, to understand their surroundings (e.g., street signs or an obviously angry motorist), how images can affect their emotional states (images of war versus image of kittens playing together), how images allow us to remember past experiences (a tour through the Italian countryside) or how we can dream of desirable future experiences, etc., etc. This relaxation exercise and helping the participants truly appreciate the importance of images in everyday life preps the participants for the next, guided imagery phase of the process.

The briefing and relaxation stage thus preps the participants who are in a relaxed state and ready to form mental images as directed by the facilitator reading them a guided imagery script (see block 24). As seen in block 23, acoustic brain entrainment music may be played during one or both of the briefing/relaxation and guided imagery stages to maintain the participants in this relaxed state. Once the participants have been briefed and relaxed, a team member reads a guided imagery script. The script is prepared by the facilitator and is linked to what the client is really looking for (e.g, the next blockbuster personal wireless device) The guided imagery script (prepared prior to the imagery session) is designed to ensure the participants imagine their best-case, earliest experiences. The script may further be designed to ensure the participants do not delve into any imagery which feels unsafe to them (e.g., enclosed spaces). For example, the participants may be instructed that they themselves are always in control of their imagery tour and can veer away from any places they feel they are leading to which they are not comfortable with. The participants are asked to take mental snapshots of their images and pick simple titles for later recollection (block 24). This completes the “imagery” phase of the process.

Each group is asked to share their images around each of the interest areas (block 25). The facilitators take field notes and audio/video tape to record the essence of what the participants are sharing with each other. It is thus at this stage where language is being matched to the images (block 26). Common themes may become apparent which help identify archetypal images and meaning in the various interest areas (block 28).

Identification of archetype images are used as a springboard to help develop problem statements. Each group is asked to generate specific problem statements that address their images and common themes. The participants are encouraged to defer judgment and to focus on generating multiple problem statements rather than focusing on a particular one. The facilitators also help the participants generate as many varied and unusual problem statements as they can using invitational stems such as “How might . . . ”, ‘How to . . . ”, and “In what ways might . . . ”. (block 27). Once a suitable number of problem statements have been generated by each group, each participant may be asked to identify what they believe to be the two most promising problem statements or “hits’. This step circles back to the use of the psychometric tool of screening those participants having the characteristics believed to make the most appropriate judgment calls on “hit” selection. Each group is assigned a unique color Post-It® which they use to identify their problem statements. Each participant then uses a uniquely colored dot on their group Post-It® to identify themselves as to the hits they selected. This allows this information to be entered into a database and also allows a facilitator to circle back to a particular participant to ask follow-up questions they feel necessary. This concludes the participants' role in the Phase I needs-identification process. They may be provided with the results of their psychometric testing and an appropriate incentive gift before they leave.

Prior to the start of the idea-generation Phase II, the Company team members and facilitators take all the hits and perform a “highlighting” procedure which assigns them into meaningful categories. The highlighting procedure clusters the hits into groups called “hotspots” which are developed based on identifying a common theme within the list of problem statements or “hits”. Once the themes are articulated, a new, more refined summary statement describes the theme (block 28).

The highlighted problem statements are provided to the client Company with all back-up data that generated them (e.g., the archetypal images and common themes and participant-coded problem statements). The Company team then selects which problem statements will be used for concept development and prioritization (block 29). They may accomplish this by answering a set of predefined questions directed at obtaining the most promising results (e.g., “Have we explored this space before”; “How do we know this need exists?”; “What applications have we developed, if any, to meet this need?”; and “Do we think this is in the scope of our business?”. This concludes Phase 1 of the process and results in a deeper understanding of customer needs, a comprehensive list of problem statements, and a clustered list of need areas.

Following selection of the problem statements by the Company team, task summaries may be developed by the CPSB team members with input from the Company team for each problem statement. Each task summary provides a high-level need statement, key background information, sample existing company applications, the desired outcome for each session, the working statement (the problem statement), and a few sample ideas. The task summaries are thus used to provide focus for the idea generation sessions.

The next Phase II is to generate ideas (block 12). The Company team is assembled, which may include people with “vested” interest (e.g., strategic marketing personnel), along with other team members which may be added such as one or more industry “thought leaders”, i.e., people who have many years experience with successful product launches in the relevant market segment. The Company team may also be administered the psychometric tool to assess the desired characteristics of people on the team (e.g., those with an orientation to change). As stated above, the Company team reviews the outcomes from Phase I and decides on several key need clusters for idea-generation.

If desired, Phase II may be carried out in more than one geographical location (e.g., both U.S. east and west coast sessions) to ensure a geographically unbiased result. Participants and groups may be recruited for Phase II based on similar or modified criteria used for participant and group selection in Phase I described above. For example, using the psychometric tool, participants having a slightly higher preference for orientation for change may be selected for this Phase II since they may be more likely to naturally generate a large number of novel ideas.

The recruited participants are assembled and briefed with the purpose of the session and a high-level overview of how they are going to work together. Participants report to their assigned groups and are provided an overview of the task summary on which they are going to focus. The CPSB team member guides the idea generation session to help the groups generate many varied and unusual ideas. Particularly, the CPSB team may guide the participants using “generation guidelines” such as, for example: 1) defer judgment; 2) strive for quantity; 3) consider combinations of ideas; and 4) “freewheel” and accept all options. Color coding as used and described above with regard to Phase I may also be used in Phase II to enable tracking of the results.

For each task summary, participants generate ideas and the participants are then asked to select ideas which they consider “hits”, i.e., those ideas that they consider to be the most promising or “life-changing”. The ideas and hits are reviewed and clustered into appropriate “themes”. Grouping the ideas into themes which are linked back to the need that generated the idea allows the team to go back to help decide which concepts to bring forward.

In Phase III—“Concept Development”, the ideas and themes are further fleshed-out into more refined, workable concepts for creative evaluation of those concepts. For this phase, a group is assembled that may include recruited participants, Company team members and thought leaders, some or all of which may be administered the psychometric tool described above. A “concept champion” may be selected for each concept who are tasked to provide the working detail of each of the concepts, complete a concept development template and short Power Point presentation. The concept development template may include a set of criteria to apply for the evaluation of the concepts (e.g.,what does the concept provide and how would it fit within the company's overall marketing strategy?). The concept champion may also be asked to write an end-user friendly concept description. Artists may be employed to sketch the concepts as they are being discussed and developed. The outcome is a final set of refined concepts for Phase IV—prioritizing the concepts.

In phase IV, the set of concepts from Phase III are ranked to provide additional directional guidance to the Company teams (see blocks 16 and 29) with the final deliverable being a small category of ideas to pursue for possible product development.

Prioritizing the concepts may be accomplished using a unique web-based tool wherein a group of psychometrically and/or demographically screened participants are sent a Concept Briefing Document to introduce them to the exercise. When ready to conduct the exercise, the participants are asked to rank the concepts and, optionally, benchmark concepts which are paired with respective new concepts. The participants may be asked to rank the concepts as they would when considering themselves in the role of one of the various segments (e.g., a personal user, a company worker, etc.). The participants may be asked to rank the concepts while in one role, and then again while in another role.

The prioritizing tool provides fast analysis of the individual rankings and can report these rankings in a high-level summary of priority. This provides directional guidance during the later stages of an exploratory process. The prioritizing tool provides its results in a manner allowing sorting by the desired parameter, e.g., by demographic segment, to provide a deeper level of analysis and insight. The demographic sorting parameter may include the following:

Name and Individual Results—shows how each person ranked the concepts

Results by Gender—shows each person's name and their gender

Results by State—shows a sum total of rankings by state

Results by Age Range—shows results within specified age ranges

Other customizable fields may include income, occupation, ethnicity, profession by sector, and employer by name, for example.

There is thus provided a novel product development process which begins with a very robust and thorough examination of the needs, both met and unmet and known and unknown, of a targeted customer base, and ends with the identification of one or more viable product concepts for possible commercial development. The use of psychometric analysis of recruited participants and guided imagery with relaxation exercises bears out a list of customer needs not otherwise ascertainable using conventional market research methods. While the invention has been described with regard to particular methods of carrying out the process, it will be appreciated to those skilled in the art that various modifications may be made thereto without departing from the full spirit and scope of the invention as defined by the claims which follow.

What is claimed is:

1. A new product development process comprising the steps of:
a) forming a consumer group having at least one participant;
b) guiding said group though a relaxation process;
c) providing a facilitator, said facilitator conducting a guided imagery process with said group, said guided imagery process comprising the step of reading a script to said participants, said script designed to elicit mental images from each of said participants;
d) matching language to said images;
e) editing said language into a set of ideas;
f) developing a set of concepts from said ideas; and
g) ranking and selecting a predetermined number of concepts to develop.

2. The process of claim 1 and further comprising the step of screening the potential participants prior to step 1 (a) to determine a predetermined participant characteristic.

3. The process of claim 2 wherein said characteristic is problem-solving style.

4. The process of claim 3 wherein said problem solving style includes orientation to change, manner of processing information, and ways of deciding options.

5. The process of claim 4 wherein said orientation to change includes one of explorer style and developer style.

6. The process of claim 4 wherein said manner of processing information includes one of external style or internal style.

7. The process of claim 4 wherein said ways of deciding options includes one of person style and task style.

8. The process of claim 1 and further comprising the step of playing brain entrainment music during the guided imagery step.

9. The process of claim 1 wherein prioritization is performed via the internet.

10. The process of claim 9 and further comprising the step of screening a second group of participants to conduct said prioritization step, said screening involving the use of at least one of psychometrics and demographics.
